(19) United States
(12) Patent Application Publication
(10) Pub. No.: US 2023/0147251 A1
(43) Pub. Date: May 11, 2023

(54) SYSTEM AND METHODS FOR OCEANIC CARBON DIOXIDE AND CLIMATE MANAGEMENT, ALGAL FOSTERING, AND INITIATION AND MAINTENANCE OF FISHERIES BY DEEP WATER PUMPING

(71) Applicant: St. Jean Orridge, Cavello Bay (BM)

(72) Inventor: St. Jean Orridge, Cavello Bay (BM)

(21) Appl. No.: 18/150,735

(22) Filed: Jan. 5, 2023

Related U.S. Application Data
(60) Provisional application No. 63/276,261, filed on Nov. 5, 2021.

(51) Int. Cl. A01K 63/04; A01K 61/10

(52) U.S. Cl. CPC A01K 63/047; A01K 61/10

(57) ABSTRACT

A system for causing an upwelling to create a fishery without altering thermoclines in a body of water, having: an electric pump housed in a floating buoy; and a heat exchanger hose having a plurality of protrusions; wherein the heat exchanger hose and the electric pump are configured to pump nutrient-rich water from a first depth of the body of water to a second depth of the body of water closer to a surface of the body of water than the first depth; wherein the plurality of protrusions is configured for transferring heat from surrounding waters to the pumped water; and wherein the system releases the pumped water only when it is warmed to around the ambient water temperature of the second depth of the body of water, such that the pumped water remains at the second depth without immediately sinking back down to the first depth.

### BACKGROUND OF INVENTION

### 1. Field of the Invention

The invention relates generally to a deliberately created man made upwelling fishery whichalso acts to remove and sequester large amounts of carbon dioxide from the atmosphere.

### 2. Description of the Related Art

Generally, there exists a problem of carbon dioxide buildup in the atmosphere, and resulting problems of global warming. There also exists a problem of depleted global fish stocks. There is a need for a solution to the problem of addressing these problems, by bringing nutrient-rich waters from deeper in the ocean to the surface. Therefore, there is a need for a solution to these problems of most effectively bringing oceanic nutrient-rich water to the surface of the ocean, referred to as the euphotic zone, and keep the nutrient-rich waters there to harvest the waters.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

Provided herein are systems and methods of utilizing nutrient-rich water that sits deeper in the ocean, by pumping the water up to the surface of the ocean to fuel phytoplankton growth and the associated marine ecosystems that develop from such a food source.

In some embodiments, an upwelling fishery is generated which mimics the effect of natural upwelling fisheries. The created upwelling fisheries may be located to best serve selected markets and can be harvested with the intention of maximizing the fishery’s sustainable yield. The man-made created upwelling fishery can be referred to as OCCMAFFIMS (Oceanic Climate CO₂ Mitigation, Algal Fostering, Fishery Initiating and Maintaining System) or generally as an artificial, generated, or created fishery system, or a specialized hose and buoy system.

Generally, the generated upwelling fishery can be designed to also at the same time absorb enormous amounts of carbon dioxide from the atmosphere into organic matter in the form of phytoplankton and all of its associated ecosystem growth. The organic matter that isa product of the ecosystem will then end up sequestered from the atmosphere through a variety of channels, such as, for example:
A. Deep ocean sequestration. Dead plankton, other marine organisms, and other organic matter (“marine snow”) sink to the seafloor and effectively become sequestered in the cold, low oxygen conditions. This is referred to as a carbon“sink” and the Earth’s oil deposits are formed in this way.
B. Sustainably encouraging and maintaining substantially larger base populations of oceanic wildlife globally. The OCCMAFFIMS may offer an avenue to help address declining oceanic fish stocks and address the world’s ever-increasing fishing pressures.
C. Replacement of traditional high carbon footprint animal proteins for human consumption. A natural / wild seafood climate positive, carbon negative, carbon sequestering alternative can be provided by the generated fishery.
D. Replacement of some fossil fuel-based fertilizers with fishmeal alternatives.
E. Providing a potential biofuel source. Use of algae as a fuel may offer analternative to current fossil fuels.
F. Promotion of cloud formation. Algae in the phytoplankton also release dimethyl sulfide, a compound that acts to promote cloud formation. Clouds generally act to shade and help cool the Earth’s surface, thus further mitigating the global warming effects of increased atmospheric CO₂.

Generally, the ecosystems which develop around the natural upwelling fisheries are prolific and represent the highest concentrations of marine life on the planet. Some of the embodiments of the invention disclosed herein allow for the creation of a man-made upwelling fishery and with the implementation of a harvest management strategy that promotes the greatest sustainable harvest of the system, it follows that the greatest amount of CO₂ gas can be removed and sequestered from the atmosphere. This harvest strategy can affect the proportions of fecal pellet sizes most prevalent in the system which has a meaningful impact on the amount of organic matter that reaches the sea floor where CO₂ sequestration will occur. As such it is an important part of the overall design and implementation of the system.

Provided herein are systems for causing an upwelling to create a fishery without altering thermoclines in a body of water, comprising: an electric pump housed in a floating buoy; and a heat exchanger hose comprising a plurality of protrusions; wherein the heat exchanger hose and the electric pump are configured to pump water from a first depth of the body of water to a second depth of the body of water, the second depth being closer to a surface of the body of water than the first depth; wherein the pumped water is nutrient-rich water; and wherein the plurality of protrusions is configured for transferring heat from surrounding waters to the pumped water within the heat exchanger hose; and wherein the system is configured to release the pumped water only when it is warmed to around the ambient water temperature of the second depth of the body of water, such that the pumped water remains at the second depth without immediately sinking back down to the first depth.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 depicts a cross-sectional transverse view of a hose for pumping water, according to an aspect.

FIG. 2 depicts a perspective of a hose for pumping water, according to an aspect.

FIG. 3 depicts a perspective view of a spherical mesh ball acting as a filter on theend of a hose at the water intake point, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

The basic unit of the hose and buoy systems disclosed herein is a high volumetric flow electric pump housed in a floating buoy. The buoy may use solar, wave energy and wind energy sources (or any combination of the three) to power the pump. The geographical region that the buoy is placed in may dictate which sources are most appropriate.

In some embodiments, nutrient-rich water is brought up from depths of around 1000 meters (m) through a hose. Generally, oceanic thermoclines pass through 80% of their temperature range in the top 1000 m of the ocean. Typically, nutrient concentrations (nitrogen (N) and phosphorus (P)) in the oceans are at roughly their maximum concentrations from depths of 800 m and below.

The waters being pumped up to the surface are released only when they are at around the ambient surface water temperature to ensure that this deep nutrient-rich water remains at the surface based on its thermal density. The saline density of the pumped water can also contribute to ensuring that the water remains at the surface level without immediately falling back down to the level from which it was pumped. Depending upon the geographical location surface waters may experience evaporation with low rainfall, which tends to make them slightly more saline dense than waters beneath them. Selection of locations where the halocline density reinforces, or at the very least does not overwhelm the thermal density considerations are important aspects considered in the invention.

In some embodiments, wherein the heat exchanger hose and the electric pump are configured to pump water from a first depth of the body of water to a second depth of the body of water, the second depth being closer to the surface of the body of water than the first depth. The design of the system brings these nutrient-rich waters to the surface as quickly and as efficiently as possible. If the waters pumped up and released at the surface are colder and denser than the surface waters, they will simply sink back down into the depths. It is therefore vital that the nutrient rich waters being pumped to the surface are warmed to about the sea surface ambient temperature, or about the temperature of the water of the second depth of the body of water, and it can be economically beneficial to do so as efficiently and as rapidly as possible, such that the water does not immediately sink back down to the first depth of the body of water.

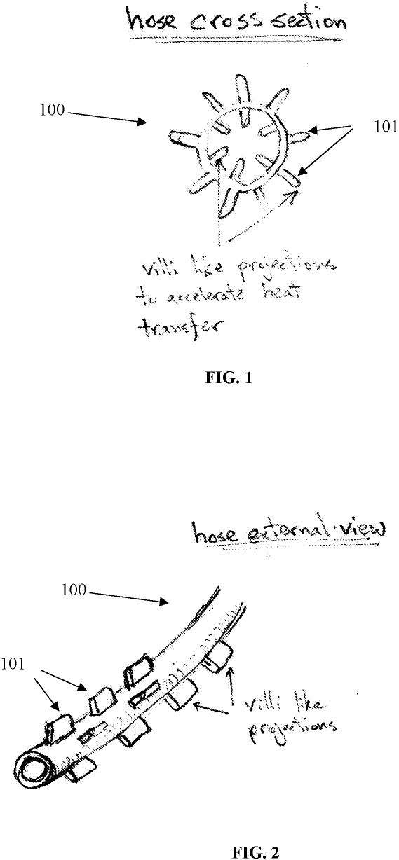

FIGS. 1 and 2 depict a cross-sectional transverse view and a perspective view, respectively, of a hose 100 for pumping water (generally referred to herein as a “heat exchanger hose,” or “hose”), used in a hose and buoy system for pumping water, according to an aspect. The hose for pumping water can be a thermally conductive hose incorporating several important designfeatures.

The protrusions shown in FIGS. 1 and 2 as 101 are excellent heat conductors and project into the center of the hose and extend outwards from the exterior surface of the hose. These protrusions have a similar effect to villi by increasing the surface area of the hose, and thereby act to rapidly transfer heat from the warmer surrounding ocean into the cooler waters being pumped up inside the hose. The protrusions also act to create turbulence inside the hose which increases and speeds up the heat transfer.

The hoses and associated protrusions of the hoses are impregnated with cost effective heat conducting materials, such as low-density pyrolytic graphite (wherein thermal conductivity is up to 1950 W/mK), boron arsenide, and any other suitable materials, to accelerate and maximize the heat transfer rate from the ocean water external to the hose, to the nutrient-rich ocean water being pumped up inside the hose.

The oceanic thermocline profile where the hose is to be located is a consideration used in calculating and optimizing the hose diameter selection to effect the fastest rate of pumping the largest possible volume. Generally, a pump rate that moves the greatest volumeof water the fastest while still accomplishing fully effective heat exchange is desirable.

At times, the pumping system may also need to slow down the pump speed to allow time for the heat exchanger hose to do its job and equalize temperatures between the ascending water inside the hose and the surrounding surface waters. In some embodiments, the volume flow can be maintained at a high level, and a greater heat exchanger hose length for the water to flow through can be used. This greater length of hose can be situated in the warmest ocean layers (the surface) to maximize its effect as long as there is a substantial horizontally flowing current/tidal flow. In some embodiments, the system may use a simple thermostatic feedback control to accomplish this.

In some embodiments, the hose design deliberately increases turbulence inside and around the hose to increase the rate of heat transfer from the warmer external waters to thewater inside the hose. The result is a reduction in flow rate and a small release of heat fromfriction into the water. Optimization of these several variables can be provided for certain embodiments of the invention.

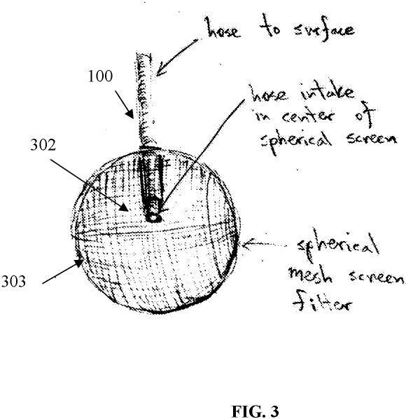

FIG. 3 depicts a perspective view of a spherical mesh ball 303 acting as a filter on the end of a hose 100 at its water intake point 302, according to an aspect. In some embodiments, the foot of the hose where water intake occurs, indicated by 302, has a spherical shaped mesh or screen attachment 303 that acts as a filter over the hose intake. This design acts to filter out any debris or sea life that could be sucked into the hose and cause a clog. In some embodiments, this design can specifically reduce the pressure of suction against the screen based on increasing the radius of the sphere used. The mesh size may be selected to allow for maximized water flow with minimized potential for blockage by debris. A larger diameter of the spherical screen can result in a lower suction pressure at its surface, and can dramatically reduce the likelihood of any clogging of the screen and hose intake.

In some embodiments, the hose and buoy systems disclosed herein are situated near river mouths in order to use the sediment in the effluent as a means of increasing sequestration of marine snow. In some embodiments, the systems disclosed herein are preferentially located in areas where iron-containing dust is naturally blown into the ocean or other bodies of water.

In some embodiments, the buoy design also has a black hose (“black hose” or “dark hose”) coiled around it above the water line, which can be incorporated into a continuation of the length of hose bringing up the nutrient-rich deeper waters when appropriate. These dark hose coils sit above the water level so that the waters being pumped to the surface can benefit from accelerated direct solar heating and/or warm air heating during the daylight hours and/or air temperatures which are warmer than the oceanic surface waters. The above-water hoses may be thermostatically incorporated into the pumping line when direct solar or airtemperature warming can be of benefit. Another benefit of the dark hose is that the darker color may minimize attention and mouthing by sharks and any other ocean creatures that may disrupt or damage the equipment.

In some embodiments, mouthing by sharks or other animals may be minimized or eliminated by infusing the heat exchanger hose with chemical deterrents. These may include any suitable chemicals or substances that discourage mouthing by animals, which may be environmentally safe.

In some embodiments, mouthing by sharks or other animals may be minimized or eliminated by embedding the heat exchanger hose with a conductive mesh configured to produce an electromagnetic field, which may discourage interaction by animals.

In some embodiments, mouthing by sharks or other animals may be minimized or eliminated by incorporating an underwater speaker into the floating buoy of the system. The speaker may be configured to play sounds that may deter the attention of sharks. For example, the sounds may be, but not limited to the sounds of other animals such as killer whales and bottlenose dolphins.

The batteries, pump, and electronics for powering the hose and buoy system are ideally located above the sea level line of the floating buoy in a sealed compartment where the lowest sealed wall of the compartment is also above the water line. In some embodiments, the drive shaft of the electric pump is the only item penetrating through the lower boundary of this sealed compartment and this design helps prevent salt-water damage to the sensitive components in the event of any seal failure. The pump motor and drive shaft are oriented such that as they spin, they provide gyroscopic stability to the buoy.

The buoys can also include GPS locating beacons to ensure that they can be easily found and retrieved in the event of loss. The buoys may also be colored brightly for greater visibility.

In some embodiments, the invention utilizes an anchoring weight and mooring line with a buoyant platform coupling point at about 100 feet below the surface (below the most intense wave energy). In such embodiments, a mooring line having a shock absorbing design can be incorporated to dampen the stress effects of oceanic currents and wave action on the mooring line. A linkage at the platform connects the mooring to the buoy on the surface. This linkage can be uncoupled before major storm events and the surface assembly removed if desired. The linkage is also designed to be the weak point so that any wear and failure in the anchorage system occurs there first, above the platform, leaving the rest of thedeeper mooring and hose still accessible to be inspected and maintained. In some embodiments, the anchoring weight and mooring line are an anchor cable running down a sleeve in the center of the hose. In such embodiments, the sleeve may help to minimize sea creatures from getting tangled or caught in the hose and anchor line.

In some embodiments, the hose and buoy systems disclosed herein use free floating buoys which have self-motility. These buoys move with the tides and GPS self-correct for any wind oroceanic current displacement.

In some embodiments, the hose and buoy systems disclosed herein utilize algae populations. Algae populations may exhibit exponential growth when there are no limiting factors. To pursue exponential growth potentials, the hose and buoy systems disclosed herein may be adjusted to account for various factors. For example, the individual pumping units may be arranged together in such a manner as to support growth without creating over-nutrification and anoxic conditions during the hours of darkness. These are conditions which may occur when the algae blooms undergo respiration at night, using more oxygen than is sustainably available, or producing more by photosynthesis during daylight hours. Accordingly, locations for the hose and buoy systems may be selected which take advantage of currents to maximize the spread and dispersal of nutrient-rich waters brought up by each pump. An equation that takes into consideration factors such as, but not limited to, current speed, pumping rate, and “real time” algal population density may be used to manage the systems to produce optimal results. As an example, satellite imagery may allow for accurate algal concentration feedback in real time.

Generally, pursuing exponential algal growth may comprise consideration of at least the following factors at any given site of a hose and buoy system:
A. Increasing exponentially the amount of nutrients brought up the euphotic zone, via the addition of more pumps down current
B. Increasing exponentially the area over which nutrients are spread out, to avoid over-nutrification.

The factors above may dictate a system’s pump positioning pattern, and the pumps’ on/off times. The positionings and on/off times may vary with each individual site.

The resulting ecosystems that may develop from the use of the hose and buoy systems disclosed herein may be harvested with the intention of maximization of sustainable yield. As an example, a fish population may be fished down to 100 fish and has 60 fish harvested in one year. The remaining 40 fish may reproduce and there are once more 100 fish to be harvested the following year. This pattern may then repeat and is therefore deemed sustainable. As another example, a population of the same species of fish is allowed to grow to 100 million. 60 million fish are harvested in one year and the remaining 40 million fish reproduce, such that there are again 100 million fish to be harvested in the following year. This pattern may then repeat and is therefore deemed sustainable. It should be understood that the examples disclosed herein are for illustrative purposes and the systems provided herein are not limited to these examples. It should also be understood that any suitable harvest strategies that maximize sustainable yield may be used.

In some embodiments, the systems disclosed herein may be used to support and enhance the populations of large migratory pelagic fisheries, such as, but not limited to, those of tuna. This means that they must be deliberately and strategically located along the migratory routes where the systems will offer the greatest benefit to these populations.

Generally, the hose and buoy systems disclosed herein act in such a manner that deliberately do not change the ocean’s thermocline profile. The embodiments disclosed herein maintain theoceanic thermocline profile as deeper nutrient-rich waters are brought to the surface.

After pumping waters to the surface, the deeper waters that have been pumped up and warmed to surface ambient temperature are then pumped back down and released at about 50 feet below the surface, to give any outgassing CO₂ a greater chance to be reabsorbed by the ocean and surface phytoplankton before potentially reaching the atmosphere. The section of hose carrying the water back downwards may be thermally non-conductive. In some embodiments, the system deliberately separates the out-flow location from the heat exchanger zones across/perpendicular to surface currents.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A system for causing an upwelling to create a fishery without altering thermoclines in a body of water, comprising:
an electric pump housed in a floating buoy; and
a heat exchanger hose comprising a plurality of protrusions;
wherein the heat exchanger hose and the electric pump are configured to pump water from a first depth of the body of water to a second depth of the body of water, the second depth being closer to a surface of the body of water than the first depth;
wherein the pumped water is nutrient-rich water; and
wherein the plurality of protrusions is configured for transferring heat from surrounding waters to the pumped water within the heat exchanger hose; and
wherein the system is configured to release the pumped water only when it is warmed to around the ambient water temperature of the second depth of the body of water, such that the pumped water remains at the second depth without immediately sinking back down to the first depth.
